(19) United States
(12) Patent Application Publication
(10) Pub. No.: US 2009/0289101 A1
(43) Pub. Date: Nov. 26, 2009

(54) METHOD FOR BALL GRID ARRAY (BGA) SOLDER ATTACH FOR SURFACE MOUNT

(76) Inventors: Yong Du, Cupertino, CA (US); John Yan, Fremont, CA (US); Niranjan Vijayaragavan, Santa Clara, CA (US)

Correspondence Address: SPANSION LLC C/O MURABITO , HAO & BARNES LLP, TWO NORTH MARKET STREET, THRID FLOOR, SAN JOSE, CA, 95113, US

(21) Appl. No.: 12/126,600

(22) Filed: May 23, 2008

(51) Int. Cl. B23K 31/02

(52) U.S. Cl. 228/180.22; 228/178

(57) ABSTRACT

A method is provided for solder reflow which includes the steps of providing a receptacle having receptacle pads formed on an upper surface and placing a component on the receptacle, the component having a ball grid array of solder balls attached thereto. The component is placed on the receptacle in a manner which aligns the solder balls with the receptacle pads on the receptacle. The method further includes the steps of placing a weight having a predetermined size and a predetermined mass on top of the component to form a stack of the receptacle, the component and the weight, and reflowing the stack to attach the component to the receptacle by exposing the stack to high temperature to reflow the solder balls.

### FIELD OF THE INVENTION

The present invention generally relates to assembly of electronic components, and more particularly relates to a method for surface mount attaching of electronic components with an improved ball grid array (BGA) solder attach process.

### BACKGROUND OF THE DISCLOSURE

Surface mount is a conventional electronic component processing technique widely-employed to attach electronic components such as semiconductor devices to receptacles such as a printed circuit board (PCB). Many electronic components are prepared for surface mount processing by a conventional attachment of a solder ball grid array (BGA) to the electronic component package. Thereafter, for example, the BGA-prepared electronic component can be mounted on a PCB or mounted into a package-on-package (POP) semiconductor assembly, wherein the electronic component in a semiconductor package is surface mounted on or over a bottom package of the POP assembly, wherein the top package is connected to a substrate of the bottom component in the POP assembly, the substrate providing the interconnection therebetween and the substrate of the bottom component acting as a receptacle for both the bottom and top electronic components and forming the means for later attachment of the POP to another receptacle component.

During such attachment process, it is necessary to expose the package-on-package assembly to high temperatures to reflow the BGA solder balls. Yet, electronic components can warp during the temperature excursion (i.e., heating the electronic package, exposing it for a time to the high temperature, and thereafter cooling the electronic component) due to a mismatching of different thermal expansion coefficients (i.e., Coefficients of Thermal Expansion (CTEs)) of the individual materials inside the electronic component. This CTE mismatch between the individual materials inside the electronic component will cause bending or warpage of the electronic component when the POP assembly cools after heating. High warpage or warpage in the direction of the top and bottom components may not match, causing the solder in the solder balls to not “wet” on the bottom pad (i.e., make contact therewith when in the liquid form), thereby maintaining the form of a solder ball attached to the top component without connecting to the bottom pad. This results in an electrical failure where there is one or more open connections between the electronic component and the bottom pad. This failure is particularly common for larger electronic components (e.g., electronic components having a surface perimeter larger than 10 mm×10 mm).

Accordingly, it is desirable to provide a method for surface mount attachment of electronic components which compensates for the warpage induced by CTE mismatch during high temperature excursion during assembly. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for solder reflow. The method includes the steps of providing a receptacle having receptacle pads formed on an upper surface and placing a component on the receptacle, the component having a ball grid array of solder balls attached thereto. The component is placed on the receptacle in a manner which aligns the solder balls with the receptacle pads on the receptacle. The method further includes the steps of placing a weight having a predetermined size and a predetermined mass on top of the component to form a stack of the receptacle, the component and the weight, and reflowing the stack to attach the component to the receptacle by exposing the stack to high temperature to reflow the solder balls.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is a cross-sectional view illustrating an unheated package-on-package stack prior to conventional surface mounting thereof into a package-on-package device;

FIG. 2 is a cross-sectional view illustrating the package-on-package arrangement of FIG. 1 after heated reflow;

FIG. 3 is a cross-sectional view illustrating a package-on-package arrangement prior to heated reflow in accordance with an embodiment of the present invention;

FIG. 4 is a cross-sectional view illustrating the package-on-package arrangement of FIG. 3 in accordance with the embodiment of the present invention after heated reflow and before removal of the weight;

FIG. 5 is a cross-sectional view illustrating the package-on-package arrangement of FIG. 3 in accordance with the embodiment of the present invention after heated reflow and removal of the weight;

FIG. 6 is a bottom planar view illustrating the weight of the package-on-package arrangement of FIG. 3 in accordance with the embodiment of the present invention;

FIG. 7 is a front right top perspective cross-sectional view across line 7-7 of FIG. 6 illustrating the weight of the package-on-package arrangement of FIG. 3 in accordance with the embodiment of the present invention; and

FIG. 8 is a flow diagram of the production process of the package-on-package arrangement of FIG. 5 in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

The following detailed description of an embodiment or embodiments of the invention is merely exemplary in nature and is not intended to limit the invention or the application and uses of the invention. Furthermore, there is no intention to be bound by any theory presented in the preceding background or the following detailed description of the embodiments.

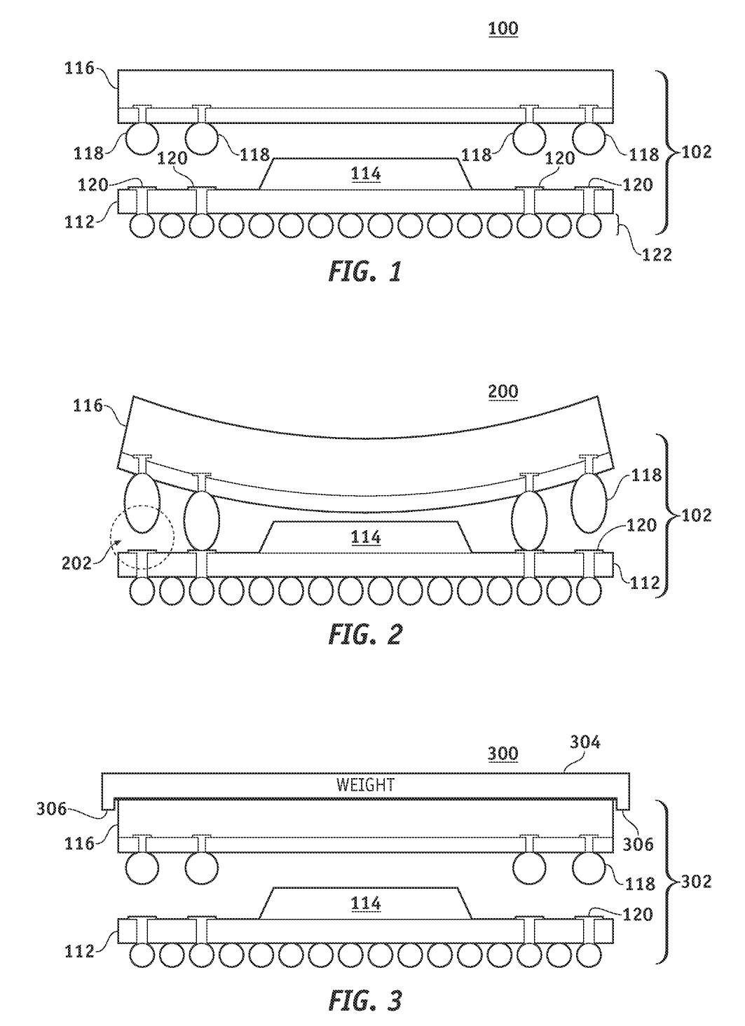

Surface mount is a processing technology which can be used to attach a prepared component to a receptacle in a highly manufacturable manner, wherein the surface mount component is prepared with an array of solder balls (called a ball grid array) attached to a bottom surface thereof. The receptacle has receptacle pads or ball pads formed on an upper surface of the receptacle to align with the solder balls when the component is placed on the receptacle. Surface mount processing technology can be used for mounting components to different receptacles, such as printed circuit boards, substrates and substrates with bottom components mounted thereon. This latter process (mounting a top component over a bottom component on a single substrate) is termed package-on-package or POP mounting. Referring to FIG. 1, a cross-sectional view 100 illustrates a POP stack 102 including a substrate 112, a bottom component 114 attached to the substrate 112, and a top component 116 having solder balls 118 of a ball grid array (BGA) attached thereto. The bottom component 114 is located on an upper surface of the substrate 112 within a predetermined perimeter and a plurality of ball pads 120 are also formed on the upper surface of the substrate 120 outside the predetermined perimeter. The cross-sectional view 100 depicts the POP stack 102 before attachment of the top component 116 to the substrate 112. The top component 116 and the bottom component 114 are typically electronic devices which operate together for a specific function and which are interconnected through wiring formed on or in the POP pad 112, such as a semiconductor memory device and a semiconductor memory controller. The POP stack 102 is conventionally packaged to form a POP assembly or POP device with a connective means on the bottom of the substrate 112, such as a BGA 122, for connecting the POP assembly to a printed circuit board or other receptacle.

As can be seen in the cross-sectional view 100, the top component 116 has a larger surface perimeter than the bottom component 114 so that the solder balls 118 of the BGA of the top component 116 can be attached to the substrate 112. The top component 116 can be surface mounted to the substrate 112 by submitting the POP stack 102 to a conventional solder reflow process. First, solder paste or flux is applied to the solder balls 118 on the top component 116 and/or to the ball pads 120 on the substrate 112. Next, the top component 116 is positioned above the substrate 112 and the solder balls 118 are aligned with the ball pads 120 using a pick-and-place machine. Next, the POP stack 102 is exposed to a high temperature (typically 220° C. to 260° C.) sufficient to reflow the solder of the solder balls 118 and thereby forming an integrated solder joint between the top component 116 and the ball pads 120. This reflow step for a BGA component such as the top component 116 is typically termed a BGA wetting process. The POP stack is then cooled to ambient temperature (approximately 25° C.), after which additional conventional processing is performed to complete the POP assembly.

FIG. 2 depicts a cross-sectional view 200 illustrating the POP stack 102 after the heated solder reflow step and/or after cooling to ambient temperature. As can be seen the top component 116 has warped during temperature excursion due to a warpage force generated by the different coefficients of thermal expansion (CTEs) of the individual materials inside the top component 116. The warpage force typically results in a bending or bowing of the top component 116 as depicted in FIG. 2. If the bending or bowing is large or the warping direction of the top component 116 and the substrate 112 does not match, the solder of the solder balls 118 will not wet on the POP pad 112 (i.e., the outer solder balls 118 do not connect to the ball pads on the substrate 112). An OPEN connection 202 leading to electrical failure occurs.

The larger the top component 116, the more likely an OPEN connection 202 will occur from warpage force generated by the temperature excursion from ambient temperature to the high reflow temperature and back to ambient temperature during the POP assembly fabrication process. The OPEN failure is particularly common for a top component 116 having a perimeter larger than 10 mm by 10 mm.

Referring to FIG. 3, a cross-sectional view 300 illustrates a POP arrangement in accordance with an embodiment of the present invention prior to a heated reflow step. The POP stack 302, includes the substrate 112, the bottom component 114, and the top component 116 with the ball grid array of solder balls 118 thereon. In accordance with this embodiment, a weight 304 is placed on the POP stack 302 prior to the BGA wetting process. The weight 304 has a predetermined size and a predetermined mass. The predetermined size and predetermined mass are determined in response to the characteristics of the top component 116.

The predetermined mass depends on elements of the top component such as the interconnect and materials of the top component 116, and can be as small as 100 mg or as large as 100 g. For example, the predetermined mass can be calculated from a measurement of the non-coplanarity of an OPEN connection 202 (FIG. 2) of a failed POP assembly wherein the predetermined mass results in sufficient downward force on the top component 116 to reduce a solder standoff of the solder balls 118 of the ball grid array of the top component 116 from the ball pads 120 of the substrate 112. This calculation of the predetermined mass may be performed utilizing modeling software which, for example, models liquid surfaces such as molten solder as the surfaces are shaped by various forces and constraints, thereby calculating a mass sufficient to provide a downward weight force on the top component 116 to maintain attachment of the solder balls 118 on the substrate 112 during the BGA wetting process (taking into account, for example, the number of solder balls 118 and the weight and height of the silicon of the component 116 above the solder balls 118) and counteract a portion of the warpage force generated by the CTE mismatch of the interconnect and the materials of the top component 116 during the BGA wetting process. One such software package is The Surface Evolver, a freeware package provided by Kenneth A. Brakke of the Mathematics Department of Susquehanna University, Pennsylvania. When determining the mass of the weight 304, it is necessary to assure that the mass of the weight 304 is not too great as too much mass will result in solder bridging between adjoining solder balls 118 or adjoining ball pads 120 of the substrate 112, an electrical failure commonly known as a SHORT failure.

The weight 304 may have a predetermined size substantially equal to the size of the top component so that the same component storage trays may be used for storage and pick-and-place. Alternatively, the weight 304 may have a lip 306 formed thereon as shown in FIG. 3. The dimension of the lip 306 is formed such that the inner perimeter of the lip 306 is larger than a surface perimeter of the top component 116 so that the lip 306 aligns the weight 304 with the top component 116 when the weight 304 is placed on the top component 116. This not only prevents separation of the weight from the POP stack 102 by lateral movement of the POP stack 302 during factory processing, but also maintains an even distribution of the mass of the weight 304 over the top component 116.

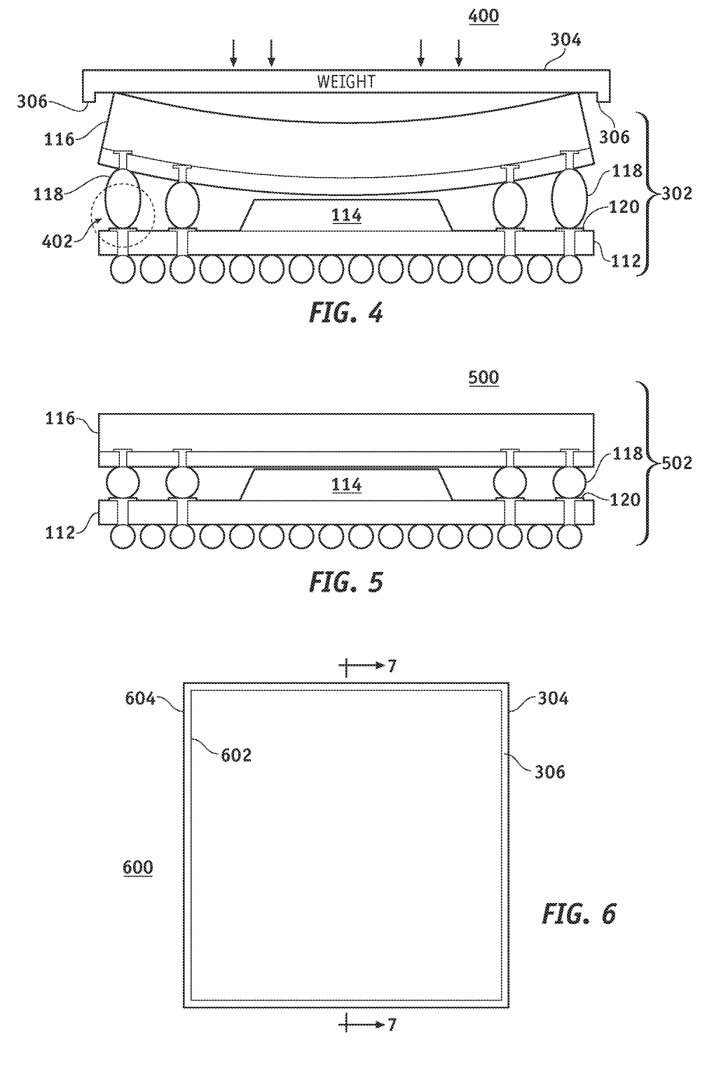

Referring to FIG. 4, a cross-sectional view 400 illustrates the POP stack 302 after heated reflow with the weight 304 thereon in accordance with the embodiment of the present invention. While the predetermined mass of the weight 304 may be insufficient to totally prevent warpage, the predetermined mass of the weight 304 is sufficient to maintain attachment of the solder balls 118 of the top component 116 to the ball pads 120 of the substrate 112 during the heated reflow and cooling steps of solder reflow, thereby advantageously preventing electrical failures of the POP assembly and increasing the yield of the POP assembly process by assuring that a connection (such as connection 402) is formed between all of the solder balls 118 of the top component and the ball pads 120 of the substrate 112. The weight 304 serves to compress the liquid solder (which is in a molten state during heated solder reflow), and direct it to the ball pads 120 on the substrate 112, thereby assuring early and continual contact between the solder balls 118 and the ball pads 120 and preventing non-contact of solder resulting in an OPEN failure.

FIG. 5 provides a cross-sectional view 500 illustrating the package stack 502 after the solder reflow process and removal of the weight 304 in accordance with the embodiment of the present invention. As can be seen from the cross sectional view 500, with application of a well-matched weight 304, the warpage of the top component during the temperature excursions necessary when heating and cooling the POP stack 302 (FIG. 3) during the solder reflow process can be prevented or greatly reduced.

FIG. 6 is a bottom planar view 600 of the weight 304 in accordance with the embodiment of the present invention. The inner perimeter 602 of the lip 306 is sufficient to accommodate the top component 116, thereby providing both stability for the POP stack 302 during the fabrication process and alignment for even distribution of the weight.

The outer perimeter 604 of the weight 304 is determined in response to the process equipment (e.g., component storage trays and pick-and-place machines) used in placement of the weight 304 on and removal of the weight 304 from the POP stack 302 (FIG. 3). In accordance with a preferred embodiment of the present invention, the outer perimeter 604 is close enough to the outer perimeter of the top component 116 to allow for use of the same pick-and-place machine to place both the top component 116 and the weight 304 on the POP stack 302, thereby reducing the costs of manufacture of the POP assemblies in accordance with the embodiment of the present invention. Furthermore, if the lip 306 is narrow enough, the outer perimeter 604 may be close enough to the outer perimeter of the top component 116 to allow for a single size of component storage trays to be used for storage of both the top components 116 and the weights 304, thereby providing a further cost reduction in the manufacture of the POP assemblies in accordance with the embodiment of the present invention.

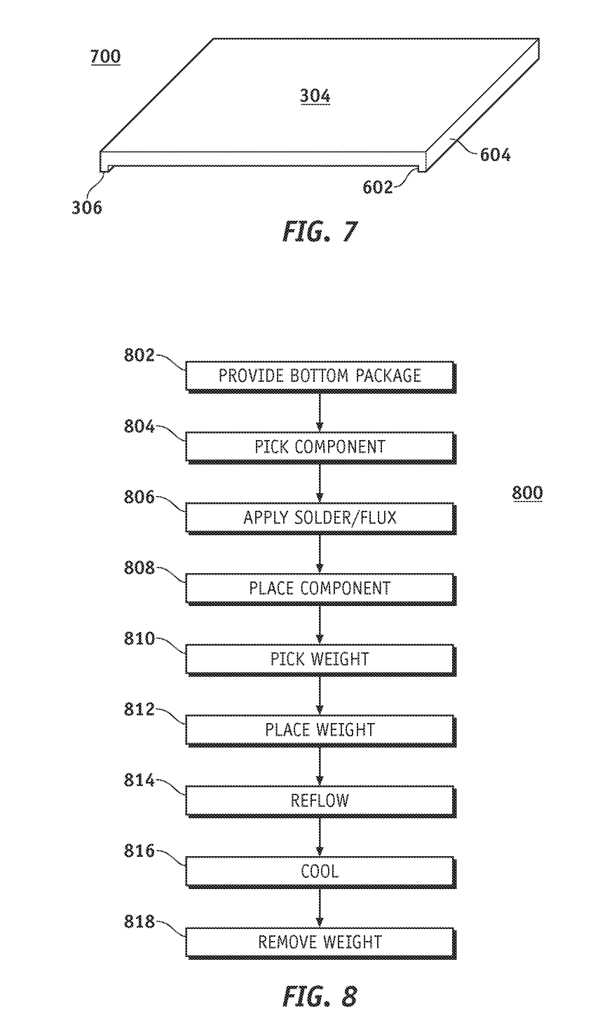

FIG. 7 is a front right top perspective view 700 of a cross-section of the weight 304 along line 7-7 of FIG. 6 in accordance with the embodiment of the present invention. The lip 306 can be seen in perspective with the inner perimeter 602 and the outer perimeter 604.

Referring to FIG. 8, a flow diagram 800 of an exemplary fabrication process of the POP stack 302 in accordance with the present embodiment is depicted. Initial to this portion of the overall POP assembly process, the substrate 112 is provided 802. The substrate 112 is typically provided at step 802 with the bottom component 116 attached thereto in any one of a multitude of assembly techniques known to those skilled in the art. In addition, as described later, the bottom component 114 could be placed on the substrate 112 with solder/flux applied to the solder balls thereof prior to step 802, but not mounted thereon, and surface mounting of the bottom component 114 to the substrate can occur simultaneously with surface mounting the top component 116 to the substrate 112. Further, the process disclosed herein does not require the bottom component 114 to be mounted on the substrate 112 as regular surface mount methodology allows for excess print solder paste to be used when no lower component is present during BGA wetting.

Once the substrate 112 is provided 802, the top component 116 is picked 804 by a pick-and-place machine from a component storage tray. Solder paste or flux is then applied 806 to the solder balls 118 of the ball grid array of the top component 116. Alternatively, step 806 could encompass applying solder/flux to the ball pads 120 on the substrate 112. The top component 116 is then placed 308 on the substrate 112.

In accordance with the present invention, the weight 304 having a predetermined mass and size is picked 810 from a component storage tray of such weights 304 by a pick-and-place machine. As stated above, it is preferable that the predetermined size of the weight 304 be such that the same component storage trays and the same pick-and-place machine used for storage and picking, respectively, of the top component 116 and the weight 304 can be utilized to reduce manufacturing costs of the POP assembly.

The pick-and-place machine then places 812 the weight 304 on the top component 116. The POP stack 302 with the weight 304 thereon is heated in a solder reflow step 814 to a sufficient temperature to liquefy the solder of the solder balls 118. As discussed above, the weight 302 has a sufficient predetermined mass to maintain attachment of the solder balls 118 to the ball pads 120 on the substrate 112 during the reflow step 814. If the bottom component 114 has a ball grid array of solder balls attached thereto and is placed on the upper surface of the substrate 112 with the solder balls thereof aligned with a plurality of ball pads formed on the substrate prior to step 804 where the top component 116 is also placed on the substrate 112, the reflow step 814 would simultaneously attach the bottom component 114 and the top component 116 to the substrate 112 by reflowing the solder balls of the bottom component 114 and the solder balls 118 of the top component 116. In this manner, additional manufacturing steps could be excluded, thereby saving both manufacturing time and manufacturing costs.

After reflow 814, the POP stack 302 is allowed to cool 816 to ambient temperature. The weight 304 remains on the POP stack 302 during cooling 816 to assure solid formation of a solder connection between the ball pads 120 on the substrate 112 and the top component 116. After cooling 816, the weight 304 is removed 818 by a weight removal machine which will pick up the weight 304 by magnetic force (if the weight 304 includes metal) or a similar mechanism. The weight 304 is then returned to a component storage tray for reuse in subsequent POP assembly processing. The reuse of the weights 304 provides additional cost savings in implementation of the methodology of the embodiment of the present invention as a unique weight 304 does not have to be provided for each POP stack 302.

Thus it can be seen that an improved method for BGA wetting and solder attach for surface mount electronic components has been provided for POP assembly wherein a weight 304 having a predetermined size and a predetermined mass compensates for the warpage induced by CTE mismatch during high temperature excursions (e.g., reflow 814 and cooling 816) during the assembly process.

While at least one exemplary embodiment concerning a package-on-package fabrication process has been presented in the foregoing detailed description of the invention, it should be appreciated that a vast number of variations exist. For example, the process of the present invention could provide an advantageous method for surface mounting electronic components on a printed circuit board. It should also be appreciated that the exemplary embodiments are only examples and are not intended to limit the scope, applicability, or configuration of the present invention in any way. Rather, the foregoing detailed description will provide those skilled in the art with a convenient road map for implementing an exemplary embodiment of the invention, it being understood that various changes may be made in the function and arrangement of elements described in the exemplary embodiment without departing from the scope of the invention as set forth in the appended claims.

What is claimed is:

1. A method for solder reflow comprising the steps of:
providing a receptacle having receptacle pads formed on an upper surface thereof;
placing a component on the receptacle, the component having a ball grid array of solder balls attached thereto, the component placed in a manner to align the solder balls with the receptacle pads on the receptacle;
placing a weight having a predetermined size and a predetermined mass on top of the component to form a stack of the receptacle, the component and the weight; and
reflowing the stack to attach the component to the receptacle by exposing the stack to high temperature to reflow the solder balls.

2. The method in accordance with claim 1 wherein the step of placing the weight comprises the step of placing the weight having the predetermined size and the predetermined mass determined to maintain attachment of the solder balls of the component to the receptacle during the reflowing step.

3. The method in accordance with claim 2 wherein the step of placing the weight comprises the step of placing the weight having the predetermined size determined in response to a surface area of the component.

4. The method in accordance with claim 3 wherein the step of placing the weight comprises the step of placing the weight having the predetermined size determined in response to the surface area of the component and a lip, the lip formed around the edges of the weight and having an inner perimeter larger than a surface perimeter of the component, wherein the lip maintains placement of the component on the receptacle during the reflowing step.

5. The method in accordance with claim 2 wherein step of placing the weight comprises the step of placing the weight having the predetermined mass determined in response to a weight force necessary to maintain the attachment of the solder balls of the component to the receptacle during the reflowing step while counteracting a portion of warpage force generated during the reflowing step, the warpage force resulting from coefficient of thermal expansion mismatch of elements of the component.

6. The method in accordance with claim 1 further comprising the steps of:
cooling the stack to ambient temperature; and
removing the weight from atop the stack.

7. The method in accordance with claim 1 wherein the step of placing the receptacle comprises the step of placing a receptacle selected from the group of receptacles comprising a printed circuit board, a substrate, and a substrate having a semiconductor die mounted thereon.

8. The method in accordance with claim 1 wherein the step of placing the component comprises the step of placing the component on the receptacle by a pick-and-place machine, and wherein the step of placing the weight comprises the step of placing the weight on the component by the same pick-and-place machine.

9. A package-on-package (POP) fabrication method for formation of a POP device comprising the steps of:
providing a substrate having a bottom component located on an upper surface thereof within a predetermined perimeter, the substrate further comprising a first plurality of ball pads formed on the upper surface and located outside the predetermined perimeter;
placing a top component on the substrate, the top component having a ball grid array of solder balls attached thereto, wherein the top component is placed on the substrate so as to align the solder balls with the first plurality of ball pads on the substrate;
placing a weight having a predetermined size and a predetermined weight on top of the component to form a stack of the substrate, the bottom component, the top component and the weight; and
reflowing the stack to attach the top component to the substrate by reflowing the solder balls of the top component.

10. The POP fabrication method in accordance with claim 9 wherein the step of placing the weight comprises the step of placing the weight having the predetermined size and the predetermined mass determined to maintain attachment of the solder balls of the top component to the substrate during the reflowing step.

11. The POP fabrication method in accordance with claim 10 wherein the step of placing the weight comprises the step of placing the weight having the predetermined size determined in response to a surface area of the top component.

12. The POP fabrication method in accordance with claim 11 wherein the step of placing the weight comprises the step of placing the weight having the predetermined size determined in response to the surface area of the top component and a lip, the lip formed around the edges of the weight and having an inner perimeter larger than a surface perimeter of the top component, wherein the lip maintains placement of the top component on the substrate during the reflowing step.

13. The POP fabrication method in accordance with claim 10 wherein step of placing the weight comprises the step of placing the weight having the predetermined mass determined in response to a weight force necessary to maintain the attachment of the solder balls of the top component to the substrate during the reflowing step while counteracting a portion of warpage force generated during the reflowing step, the warpage force resulting from coefficient of thermal expansion mismatch of elements of the top component.

14. The POP fabrication method in accordance with claim 9 further comprising the steps of:
cooling the stack to ambient temperature; and
removing the weight from atop the stack.

15. The POP fabrication method in accordance with claim 9 wherein the reflowing step comprises the step of reflowing the stack to attach the top component to the substrate by exposing the stack to high temperature in the temperature range of 220 to 260 degrees Centigrade (220° C. to 260° C.).

16. The POP fabrication method in accordance with claim 9 wherein the step of placing the top component comprises the step of placing the top component on the substrate by a pick-and-place machine, and wherein the step of placing the weight comprises the step of placing the weight on the top component by the same pick-and-place machine.

17. The POP fabrication method in accordance with claim 9 wherein the step of providing a substrate having a bottom component located on an upper surface thereof comprises the step of providing a substrate having a bottom component located within the predetermined perimeter on the upper surface thereof, the bottom component having a ball grid array of solder balls attached thereto and the substrate further comprising a second plurality of ball pads formed on the upper surface and located inside the predetermined perimeter, wherein the bottom component is located on the substrate so as to align the solder balls of the bottom component with the second plurality of ball pads on the substrate, and wherein the step of reflowing the stack comprises the step of reflowing the stack to attach the bottom component and the top component to the substrate by reflowing the solder balls of the bottom component and the solder balls of the top component.

18. A weight for assisting solder ball attachment of a component having a ball grid array (BGA) to a receptacle during a BGA wetting process, the weight having a predetermined size and a predetermined mass, the predetermined size determined in response to a surface area the component and the predetermined mass determined in response to coefficient of thermal expansion mismatch of elements of the component.

19. The weight in accordance with claim 17 comprising a lip formed around the edges of the weight, the lip having an inner perimeter larger than a surface perimeter of the component for maintaining placement of the component on the receptacle during the BGA wetting process.

20. The weight in accordance with claim 17 wherein the predetermined mass is determined in response to a weight force necessary to maintain attachment of the ball grid array to the receptacle during the BGA wetting process while counteracting a portion of warpage force generated during the BGA wetting process, the warpage force resulting from the coefficient of thermal expansion mismatch of the elements of the component.
